(19) United States
(12) Patent Application Publication
(10) Pub. No.: US 2026/0140666 A1
(43) Pub. Date: May 21, 2026

(54) STORAGE SYSTEM

(71) Applicant: SAMSUNG ELECTRONICS CO., LTD., Suwon-si (KR)

(72) Inventor: Seungkyu HONG, Suwon-si (KR)

(73) Assignee: SAMSUNG ELECTRONICS CO., LTD., Suwon-si (KR)

(21) Appl. No.: 19/282,621

(22) Filed: Jul. 28, 2025

(30) Foreign Application Priority Data
Nov. 18, 2024 (KR) 10-2024-0164010

(51) Int. Cl. G06F 3/06

(52) U.S. Cl. CPC G06F 3/0659; G06F 3/0604; G06F 3/0679

(57) ABSTRACT

A storage system according to the present disclosure includes a storage device including a queue depth manager configured to detect a queue depth corresponding to the number of commands being processed and output the queue depth, and a host device including a memory and a performance controller. The memory is configured to store reference value of an element for determining the performance of the storage device and setting values of parameters for meeting the reference value of the element. The performance controller is configured to receive the queue depth and change the setting values of the parameters based on a comparison result between a measured value of the element corresponding to the commands and the reference value of the element.

### CROSS-REFERENCE TO RELATED APPLICATION

This application claims priority to and the benefit of Korean Patent Application No. 10-2024-0164010 filed with the Korean Intellectual Property Office on Nov. 18, 2024, the entire contents of which are incorporated herein by reference.

### BACKGROUND OF THE INVENTION

The present disclosure relates to a storage system.

Large-capacity storage devices such as SSDs (Solid State Drives) are mainly used in connection with a host device, and read and write operations are executed on the SSD in response to read and write requests from the host device.

Meanwhile, depending on the environment of the host device, the storage device may not be able to meet the performance required by the host device. This causes the storage system not to provide stable service. Therefore, in order for the storage system to provide stable service, the host device may need to dynamically adjust parameter values within the storage device.

### SUMMARY OF THE INVENTION

The present disclosure attempts to provide a storage system including a storage device capable of providing performance required by a host device.

A storage system according to an embodiment may include a storage device including a queue depth manager configured to detect a queue depth corresponding to the number of commands being processed and output the queue depth, and a host device including a memory and a performance controller. The memory is configured to store reference value of an element for determining the performance of the storage device and setting values of parameters for meeting the reference value of the element. The performance controller is configured to receive the queue depth and change the setting values of the parameters based on a comparison result between a measured value of the element corresponding to the commands and the reference value of the element.

A method of operating a host device according to an embodiment may include of receiving a reference value of latency of a storage device determined according to a queue depth and a workload pattern and setting values of parameters of the storage device for the reference value; receiving the queue depth as the number of the commands queued in a command queue of the storage device; monitoring whether the queue depth is within a first range for a first time; determining the workload pattern of the commands; measuring the latency of the commands and obtaining the measured latency; comparing the measured latency and the reference value; and adjusting the setting values of the parameters based on a comparison result between the measured latency and the reference value.

A storage device according to an embodiment may include a memory configured to store a reference value of latency according to a queue depth and a workload pattern and setting values of parameters to meet the reference value, a queue depth manager configured to detect the queue depth corresponding to the number of the commands being processed and output the queue depth, and a parameter controller configured to receive changed setting values of the parameters.

### BRIEF DESCRIPTION OF THE DRAWINGS

FIG. 1 is a diagram showing a storage system according to some embodiments.

FIG. 2 is a schematic block diagram for explaining the memory controller of FIG. 1.

FIG. 3 is a table showing reference values of latency stored in memory according to some embodiments.

FIG. 4 is a table showing setting values of parameters related to latency stored in memory according to some embodiments.

FIG. 5 is a schematic block diagram of a storage system according to some embodiments.

FIG. 6 is a diagram for explaining the operation of a performance control unit according to some embodiments.

FIG. 7 is a graph showing the queue depth received by a performance control unit during a measurement window according to some embodiments.

FIG. 8 is a table of reference values stored in a buffer memory in an exemplary embodiment.

FIG. 9 is a table of parameter setting values stored in a buffer memory in an exemplary embodiment.

FIG. 10 indicates parameters according to an exemplary embodiment.

FIG. 11 is a flowchart of the operation of a storage system according to some embodiments.

FIG. 12 is a table showing reference values of power consumption or throughput of a storage device stored in memory in an exemplary embodiment.

FIG. 13 indicates parameters according to an exemplary embodiment.

FIG. 14 is a diagram illustrating a system to which a storage device according to some embodiments is applied.

### DETAILED DESCRIPTION OF THE EMBODIMENTS

In the following detailed description, only certain embodiments of the present invention have been shown and described, simply by way of illustration. Below, with reference to the attached drawings, an embodiment of the present invention is described in detail so that a person having ordinary skill in the art to which the present invention pertains can easily practice the present invention. As those skilled in the art would realize, the described embodiments may be modified in various different ways, all without departing from the spirit or scope of the present invention. However, the present invention may be implemented in various different forms and is not limited to the embodiments described herein.

Accordingly, the drawings and description are to be regarded as illustrative in nature and not restrictive. Like reference numerals designate like elements throughout the specification. And in order to clearly explain the present invention in the drawings, parts that are not related to the explanation are omitted, and similar parts are given similar drawing reference numerals throughout the specification.

In the flowchart described with reference to the drawings, the order of operations may be changed, several operations may be merged, some operations may be split, and certain operations may not be performed.

In addition, expressions written in the singular may be construed as either singular or plural, unless the express words “one” or “single” are used. Terms containing ordinal numbers, such as first, second, and the like, may be used to describe various Components, but the Components are not limited by such terms. These terms may be used to distinguish one component from another.

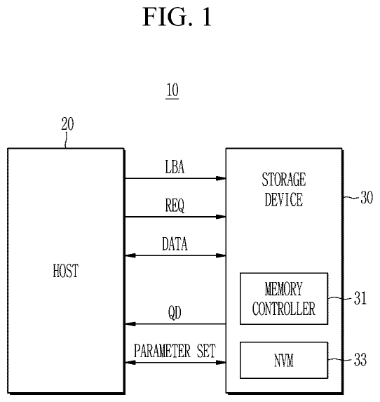

FIG. 1 is a diagram showing a storage system according to some embodiments.

In an embodiment, the storage system 10 may be included in user devices such as a personal computer, a laptop computer, a server, a media player, a digital camera, or an automotive device such as a navigation system, a black box, or an automotive electrical device.

Alternatively, the storage system 10 may be included in a mobile system such as a mobile phone, a smart phone, a tablet personal computer, a wearable device, a healthcare device, or an Internet of Things (IoT) device.

As illustrated in FIG. 1, the storage system 10 includes a host device 20 and a storage device 30.

The host device 20 may be one of a plurality of host devices.

The host device 20 may control the overall operation of the storage system 10. The host device 20 can communicate with the storage device 30 through various interfaces. For example, the host device 20 may communicate with the storage device 30 through various interfaces such as USB (Universal Serial Bus), MMC (MultiMediaCard), PCI-E (PCI-Express), ATA (AT Attachment), SATA (Serial AT Attachment), PATA (Parallel AT Attachment), SCSI (Small Computer System interface), SAS (Serial Attached SCSI), ESDI (Enhanced Small Disk Interface), IDE (Integrated Drive Electronics), NVMe (Non-Volatile Memory Express), etc. The host device 20 may provide a logical block address (LBA) and a request signal (REQ) to the storage device 30. Additionally, the host device 20 may transmit data (DATA) to the storage device 30 and/or receive data (DATA) from the storage device 30. The storage device 30 may include a memory controller 31 and a nonvolatile memory (NVM) 33. The storage device 30 may store data (DATA) or process data (DATA) in response to a request signal (REQ) from the host device 20. The memory controller 31 may be configured to access nonvolatile memory 33 in response to a request signal (REQ) of the host device 20. A memory controller 31 may be configured to provide an interface between a nonvolatile memory 33 and a host device 20. Additionally, the memory controller 31 may be configured to drive firmware for controlling the non-volatile memory 33. The nonvolatile memory 33 may be implemented as or similar with a solid state drive (SSD), a smart SSD, an embedded Multimedia Card (eMMC), an embedded Universal Flash Storage (UFS) memory device, a UFS memory card, a Compact Flash (CF), a Secure Digital (SD), a Micro-SD (Micro Secure Digital), a Mini-SD (Mini Secure Digital), an xD (extreme Digital), a Memory Stick, or a similar form.

Meanwhile, depending on the environment of each host device 20, the storage device 30 may not meet the performance required by the host device 20. Here, the performance required by the host device 20 may be the performance required by the customer using the storage system 10 or the performance required by the application of the host device 20 accessing the storage device 30.

In an embodiment, element determining the performance of the storage device 30 may include latency. For example, if the host device 20 is the first host device among a plurality of hosts, the storage device 30 may satisfy the latency required by the first host device, but if the host device 20 is the second host device among a plurality of hosts, the storage device 30 may not satisfy the latency required by the second host device because of the internal environment of the second host device or the workload pattern of the second host device.

Specifically, when a second host device transmits multiple read requests and write requests, since read requests have a higher priority than write requests, many write commands are queued and the read command may be processed first. Accordingly, the queue depth may increase and the tail latency of the commands may rapidly increase. This can result in excessive latency for write commands.

In such a case, the second host device may reduce the write delay of the storage device 30 or control the number of write commands queued in the queue of the storage device 30 to enable the storage device 30 to meet the performance required by the second host device.

Therefore, depending on the usage environment of each host device 20 or the workload pattern of each host device 20, the host device 20 needs to control the parameter values inside the storage device 30.

Hereinafter, the host device 20 may refer to one of a plurality of host devices.

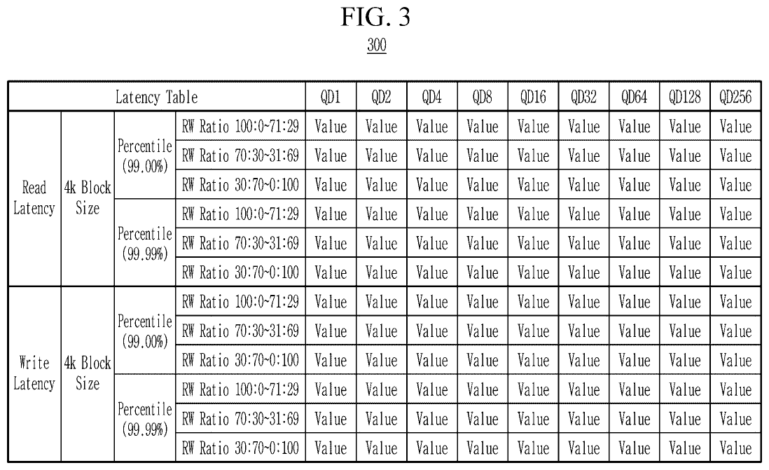

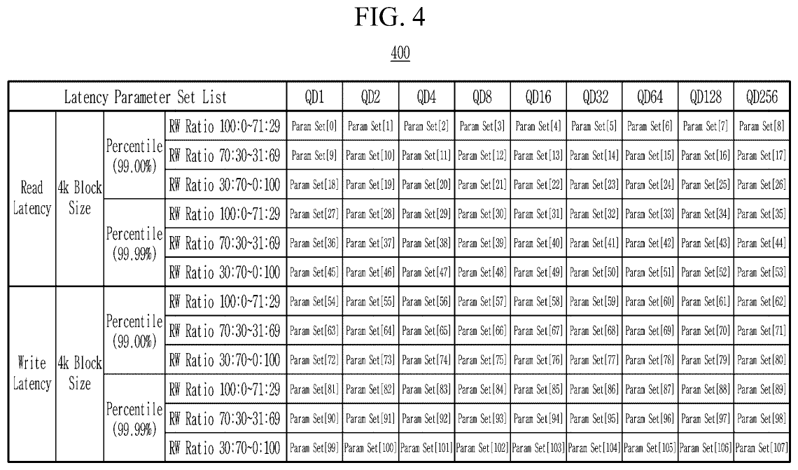

In an embodiment, host device 20 may receive latency reference value from the storage device 30 in advance. The latency reference value may be a predetermined value that is optimized in a pre-shipment test evaluation of the storage device 30 to meet the performance required by the host device 20. In an embodiment, the host device 20 may receive in advance the setting values of parameters related to latency from the storage device 30. Here, parameters related to latency may include, but are not limited to, read delay, write delay, and erase suspend delay. The setting values of parameters related to latency may be predetermined values, as values of parameters optimized in a pre-shipment test evaluation of the storage device 30, so that the storage device 30 satisfies the latency reference value. A detailed description of the latency reference value and parameters related to latency is described below with reference to FIG. 3 and FIG. 4.

In an embodiment, the storage device 30 may transmit a queue depth (QD) to the host device 20 for a predetermined period of time or periodically as the number of commands that the storage device 30 is currently processing. The host device 20 may check whether the queue depth is within a certain range during the measurement window and determine the workload of commands corresponding to the queue depth. In an embodiment, the host device 20 may measure the latency of commands corresponding to the queue depth and compare the latency measured by the host device 20 with a latency reference value received from the storage device 30. If the measured latency is greater than a latency reference value, the host device 20 may change values of parameters related to the latency received from the storage device 30 and transmit it to the storage device 30. The storage device 30 may process a host request according to values of parameters received from the host device 20.

A storage system 10 according to an embodiment may allow a host device 20 to dynamically adjust values of internal parameters of a storage device 30 according to the usage environment of the host device 20. This has the advantage of enabling the storage device 30 to meet the performance required by the host device 20 depending on the usage environment of the host device 20.

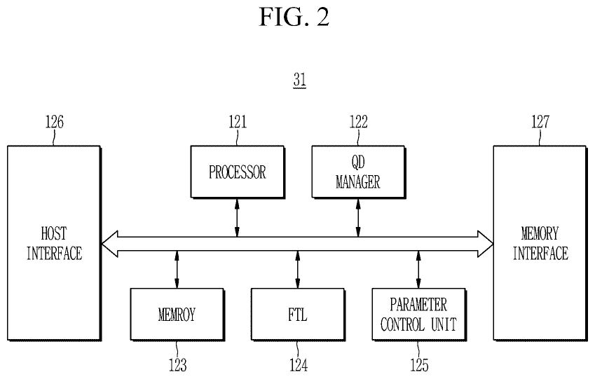

FIG. 2 is a schematic block diagram for explaining the memory controller of FIG. 1.

The memory controller 31 may include a processor 121, a queue depth manager (QD manager) 122, a memory 123, a flash translation layer (FTL) 124, a parameter control unit (or a parameter control circuit or a parameter controller) 125, a host interface 126, and a memory interface 127.

The processor 121 may control the overall operation of the memory controller 31. The processor 121 may control the memory controller 31 by running firmware loaded into the FTL 124. In an embodiment, the processor 121 may include a central processing unit (CPU), a controller, or an application specific integrated circuit (ASIC).

In an embodiment, the memory 123 may store a latency reference value as metadata. Specifically, the latency reference value may be an optimized value in a pre-shipment test evaluation of a storage device 30 (FIG. 1) to meet the performance required by the host device 20 (FIG. 1), and may be determined based on the queue depth and workload pattern.

In an embodiment, the memory 123 may store setting values of parameters related to latency as metadata. Specifically, the setting values of parameters related to latency may be optimized values in a pre-shipment test evaluation of the storage device 30 to meet the reference value of latency and determined according to the queue depth and workload pattern. A detailed description of the latency reference value and the setting values of parameters related to latency is described with reference to FIG. 3 and FIG. 4.

FIG. 3 is a table showing reference values of latency stored in memory according to some embodiments.

In an exemplary embodiment, the reference values of latency may be stored in a table, and the reference values of latency may be differentiated according to queue depth and workload pattern. Hereinafter, the table indicating the latency reference values is referred to as the reference value table.

In one embodiment, the latency of the reference value table 300 may be distinguished into read latency and write latency, and the reference value of the latency may have different values depending on the queue depth and workload pattern. Here, workload patterns may include, but are not limited to, data chunk size, tail latency percentile, and the ratio of read requests to write requests (RW ratio). The queue depth section and workload pattern section of the reference value table 300 may be determined differently depending on the test evaluation criteria or customer request.

FIG. 4 is a table showing setting values of parameters related to latency stored in memory according to some embodiments. In an exemplary embodiment, the setting values of the parameters may be stored in a table, and the setting values of the parameters may be distinguished according to the queue depth and the workload pattern. Hereinafter, the table indicating the setting values of parameters related to latency is referred to as the parameter setting value table.

In an embodiment, the setting values of the parameter setting value table 400 may have different values depending on the queue depth and workload pattern. Here, workload patterns may include, but are not limited to, data chunk sizes, percentiles of tail latency, and the ratio of read requests to write requests. The queue depth section and workload pattern section of the parameter setting value table 400 may be determined differently depending on the test evaluation criteria or customer request.

In an embodiment, the memory 123 may transfer the reference value table 300 and parameter setting value table 400 stored in the memory 123 to the host device 20 when booting the storage system 10.

Referring to FIG. 2, in an embodiment, the memory controller 31 may include a queue depth manager 122.

The queue depth manager 122 may detect the queue depth as the number of commands being processed by the storage device 30 and transmit the queue depth to the host device 20. The queue depth manager 122 may detect the queue depth as the number of commands waiting to be entered into the command queue of the storage device 30 and transmit the queue depth to the host device 20. The queue depth manager 122 may transmit the queue depth to the host device 20 for a predetermined period of time or periodically.

In an embodiment, the memory controller 31 may include a parameter control unit 125. The parameter control unit 125 may receive changed parameter setting values from the host device 20 and control the storage device 30 so that the storage device 30 operates according to the changed parameter setting values. The parameter control unit 125 may update the changed parameter setting values in the parameter setting value table 400.

The flash translation layer (FTL) 124 may include firmware or software that manages data read, write, and erase operations of the storage device 30. The firmware of FTL 124 may be executed by the processor 121.

The host interface 126 may provide an interface between the host device 20 and the memory controller 31. The memory controller 31 may communicate with the host device 20 through the host interface 126. For example, the host interface 126 may be one of various standardized interfaces.

The memory interface 127 may provide signal transmission and reception with nonvolatile memory 33 (of FIG. 1). The memory interface 127 may transmit a command together with data to be written to the nonvolatile memory 33 to the nonvolatile memory 33, or receive data read from the nonvolatile memory 33.

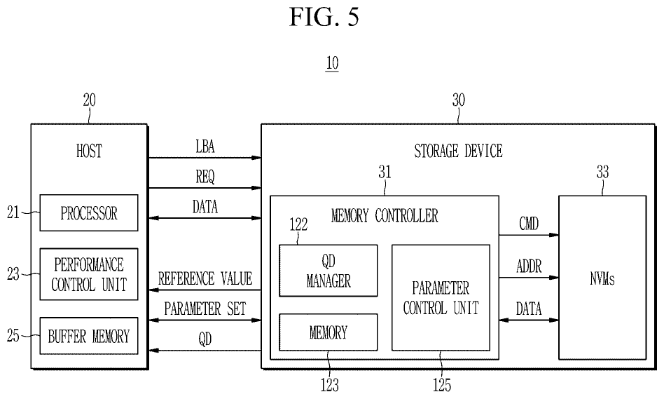

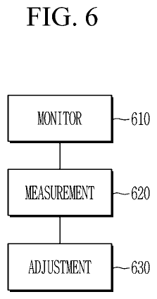

FIG. 5 is a schematic block diagram of a storage system according to some embodiments. The block diagram of FIG. 5 is a more detailed block diagram of the storage system of FIG. 1, and for convenience of explanation, the configuration of the memory controller 31 is shown only as a queue depth manager 122, a memory 123, and a parameter control unit 125. FIG. 5 is explained with reference to FIG. 6 to FIG. 10. Meanwhile, the host device 20 of FIG. 5 may refer to one of a plurality of host devices.

In one embodiment, the host device 20 may include a processor 21, a performance control unit (or a performance control circuit or a performance controller) 23, and a buffer memory 25.

In an embodiment, the processor 21 may control overall operation of the host device 20. For example, based on the control of the processor 21, the host device 20 may provide a logical block address (LBA) and a request signal (REQ) to the storage device 30. The memory controller 31 may generate an address (ADDR) corresponding to the logical block address (LBA) and a command (CMD) corresponding to the request signal (REQ), and may transfer the address (ADDR), the command (CMD), and/or the data (DATA) to the nonvolatile memory 33.

In an embodiment, the host device 20 may receive a reference value of latency and set values of parameters related to latency from the storage device 30. In an embodiment, the host device 20 may receive a reference value of latency from the storage device 30 as a reference value table 300 (of FIG. 3), receive setting values of parameters related to latency as a parameter setting value table 400 (of FIG. 4), and store the reference value table 300 and the parameter setting value table 400 in the buffer memory 25. When booting the storage system 10, the reference value table 300 and the parameter setting value table 400 may be transferred from the storage device 30 to the buffer memory 25 of the host device 20.

In an embodiment, the performance control unit 23 may receive a queue depth (QD) from the memory controller 31, determine a workload pattern of commands corresponding to the queue depth (QD), and measure latency. Hereinafter, the latency measured by the performance control unit is referred to as measured latency.

The performance control unit 23 may compare the measured latency with the reference value of the latency in the reference value table 300. The performance control unit 23 may change the parameter setting value according to the comparison result between the measured latency and the reference value of the latency. The operation method of the performance control unit 23 is described later with reference to FIG. 6 to FIG. 10.

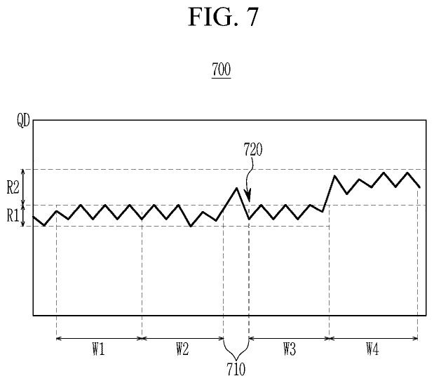

FIG. 6 is a diagram for explaining the operation of a performance control unit according to some embodiments, and FIG. 7 is a graph showing the queue depth received by a performance control unit during a measurement window according to some embodiments. A performance control unit 23 according to an embodiment may perform a queue depth monitoring operation (monitor) 610, an operation of identifying a workload pattern of commands corresponding to the queue depth and measuring latency (measurement) 620, and an operation of adjusting parameter setting values related to latency (adjustment) 630.

In an embodiment, the performance control unit 23 may monitor the queue depth 610. Specifically, the performance control unit 23 may receive the queue depth (QD) from the queue depth manager 35 for a predetermined time or periodically. In an exemplary embodiment, the queue depth (QD) being within a predetermined range during the measurement window may refer to the queue depth (QD) being 1 during the measurement window, or the queue depth (QD) being greater than or equal to 2ⁿ⁻¹ and less than or equal to 2ⁿ during the measurement window. In here, n is an integer greater than or equal to 2. However, it is not limited thereto, and the section for determining whether the queue depth is within a predetermined range during the measurement window may be changed in various range.

The graph 700 of FIG. 7 represents the queue depth (QD) received by the performance control unit 23 from the storage device 30 during a plurality of measurement windows. Specifically, the performance control unit 23 may receive the queue depth (QD) from the queue depth manager 35, check the range of the queue depth (QD), and determine that the queue depth (QD) is included in a predetermined range R1 during the first measurement window W1. Here, the given range R1 may refer to an interval greater than or equal to 2 and less than or equal to 4, but is not limited thereto. The performance control unit 23 may receive the queue depth (QD) from the queue depth manager 35, check the range of the queue depth (QD), and determine that the queue depth (QD) is included in a predetermined range R1 during the second measurement window W2. However, the performance control unit 23 may check that the queue depth (QD) is not included in a predetermined range R1 during the time range 710 after the second measurement window W2. Specifically, the performance control unit 23 may check the queue depth (QD) after the second measurement window W2 and determine that the range R2 including the queue depth (QD) is not maintained during the measurement window. At this time, the performance control unit 23 may set the next received queue depth (QD) as a new starting point 720 of measurement window, and check whether the queue depth (QD) is included in a predetermined range R1 during the third measurement window W3. The performance control unit 23 may check the queue depth (QD) during the fourth measurement window W4 and determine that the queue depth (QD) is within a predetermined range R2. Here, the given range R2 may refer to a section greater than or equal to 4 and less than or equal to 7, but is not limited thereto. Meanwhile, the size of each measurement window may be the same or different, and the number of measurement windows may be set variably.

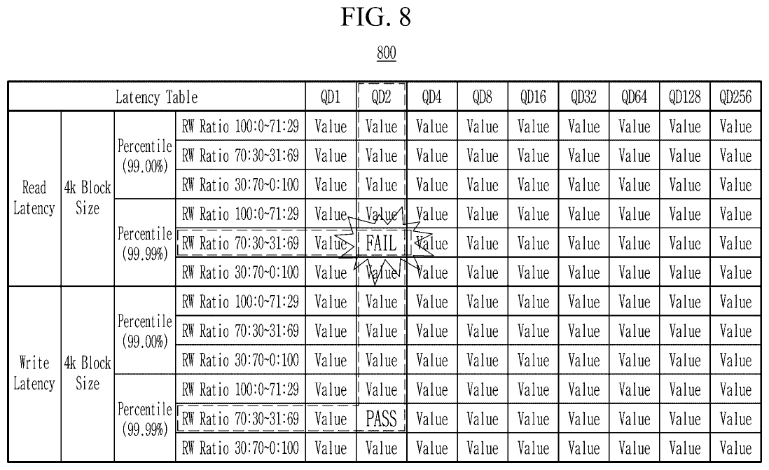

FIG. 8 is a table of reference values stored in a buffer memory in an exemplary embodiment. Referring to FIG. 6, if the performance control unit 23 determines that the queue depth (QD) is within a predetermined range during the measurement window, the performance control unit 23 may determine a workload pattern of commands corresponding to the queue depth (QD) and measure latency 620. Referring also to FIG. 8, in an exemplary embodiment, the performance control unit 23 may determine that the queue depth (QD) is within a predetermined range (e.g., 2 or more and less than 4) during the first measurement window W1, and determine a workload pattern of commands corresponding to the queue depth (e.g., QD2) received during the first measurement window W1, wherein the workload pattern may include a data chunk size (4K Block size), a percentile of tail latency (99.99% percentile), and a ratio of read requests to write requests (RW ratio, 70:30 to 31:69).

In an embodiment, if the performance control unit 23 determines that the queue depth is within a predetermined range during the first measurement window W1, it may measure the latency of commands corresponding to the queue depth QD2 received during the first measurement window W1. Here, the latency of the commands may be the time from the time the host device 20 transmits a request signal instructing data processing to the storage device 30 to the time the storage device 30 transmits a signal instructing that data processing is complete to the host device 20.

In an embodiment, the performance control unit 23 may compare measured latency and reference value table 800 stored in buffer memory 25 based on workload pattern of the commands corresponding to the queue depth QD2. Referring to FIG. 8, the performance control unit 23 may determine the data chunk size (4K Block size), the percentile of tail latency (99.99% percentile), and the ratio of read requests to write requests (RW ratio, 70:30 to 31:69) as the workload pattern of commands corresponding to the queue depth QD2 and the queue depth QD2 received during the first measurement window W1, and compare the measured latency with the latency reference value. As shown in FIG. 8, the read latency may be greater than the reference value (i.e., FAIL), and the write latency may satisfy the reference value (i.e., PASS). Accordingly, the performance control unit 23 may adjust the setting values of parameters related to read latency. Meanwhile, the results of the comparison between the measured latency and the latency reference value are not limited to this. For example, the read latency may meet a threshold value and the write latency may be greater than the threshold value, or both the read latency and the write latency may be greater than the threshold value, or both the read latency and the write latency may meet the threshold value.

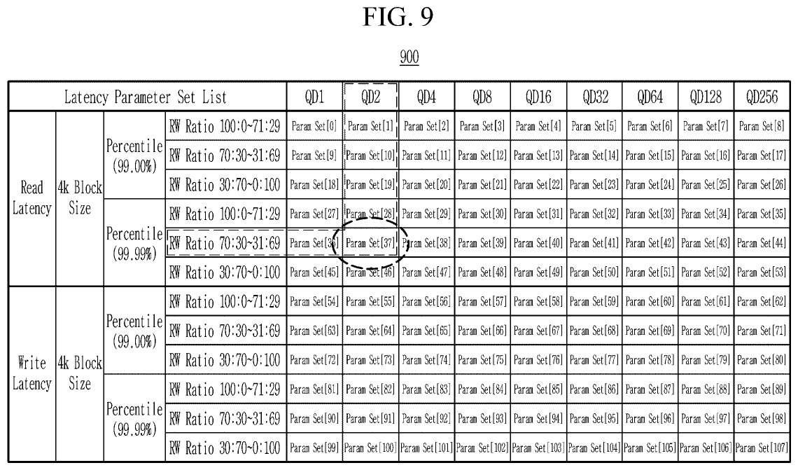

FIG. 9 is a table of parameter setting values stored in a buffer memory in an exemplary embodiment.

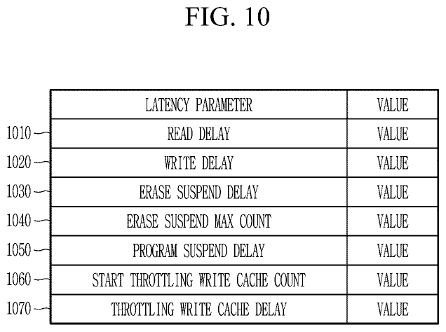

Referring to FIG. 6, the performance control unit 23 may adjust parameter setting values related to latency based on the comparison result between the measured latency and the reference value of latency 630. Referring also to FIG. 9, the performance control unit 23 may read the parameter setting value table 900 stored in the buffer memory 25. For example, the performance control unit 23 may read the queue depth QD2 received from the storage device 30 during the first measurement window W1 and the parameter setting values according to the workload pattern of the commands corresponding to the queue depth QD2, and adjust the parameter setting values to control the read latency of the commands corresponding to the queue depth QD2. The parameters of the performance control unit 23 is descripted with reference to FIG. 10.

FIG. 10 indicates parameters according to an exemplary embodiment.

In an embodiment, the performance control unit 23 may change the setting values of some or all of the parameters of FIG. 10 to control the read latency and/or write latency of commands corresponding to the queue depth.

For each parameter, the read delay 1010 controls the delay of the read command. As the setting value of the read delay decreases, the latency of the read command may be reduced. However, the latency of the write command may increase.

Write delay 1020 controls the delay of the write command. As the setting value of the write delay decreases, the latency of the write command may be reduced. However, the latency of read commands may increase.

Erase suspend delay 1030 controls the delay after an erase suspend until a read or write command is processed. As the erase pause delay decreases, the latency of read and write commands may be reduced. However, the latency of the erase command may increase.

Erase suspend max count 1040 controls the number of read or write command entries allowed within one erase operation. As the erase delay max count decreases, the latency of read and write commands may be reduced. However, the latency of the erase command may increase.

The program suspend delay 1050 controls the delay after the program (write) suspend until a read command is processed. As the program pause delay decreases, the latency of read commands may be reduced. However, the latency of the write command may increase.

The start throttling write cache count 1060 controls the number of write commands that the buffer cache that stores write commands can store. The throttling write cache delay 1070 controls the delay when the number of write commands stored in the buffer cache is greater than or equal to the starting throttling write cache count. In other words, if the number of write commands stored in buffer cache is greater than or equal to the starting throttling write cache count, it is given a delay determined by the throttled write cache delay time. Although the latency of the overall write count may increase due to the latency, if there is no latency, the number of write commands stored in the buffer cache increases, which leads to a very long tail latency of the write commands.

In an embodiment, the performance control unit 23 may select a parameter to control the latency of commands and change the setting value of the parameter. At this time, the changed parameter may be different according to the kind of the commands. For example, the performance control unit 23 may adjust at least one of the set values of the read delay 1010, the erase suspend delay 1030, the erase suspend max count 1040, and the program suspend delay 1050 to control the read latency of commands corresponding to the queue depth. Alternatively, the performance control unit 23 may adjust at least one of the set values of the write delay 1020, the erase suspend delay 1030, the erase delay max count 1040, the start throttling write cache count 1060, and the throttling write cache delay 1070 to control the write latency of commands corresponding to the queue depth. However, it is not limited to this.

In an embodiment, the performance control unit 23 may transmit the changed parameter setting values to the parameter control unit 125 (of FIG. 2) of the storage device 30. The parameter control unit 125 may control the storage device 30 so that the storage device 30 operates according to the changed parameter setting values. The parameter control unit 125 may update the changed parameter setting values in the memory 123 (of FIG. 2).

In an embodiment, the performance control unit 23 may perform the operations described above for commands corresponding to queue depths (QD) received during the second measurement window W2, the third measurement window W3, and the fourth measurement window W4.

Meanwhile, although the performance control unit 23 is depicted here as being located outside the processor 21 (FIG. 2), it is not limited thereto. The performance control unit 23 may be included in the processor 21, or some configuration of the performance control unit 23 may be included in the processor 21 so that the processor 21 may perform some of the operations of the performance control unit 23.

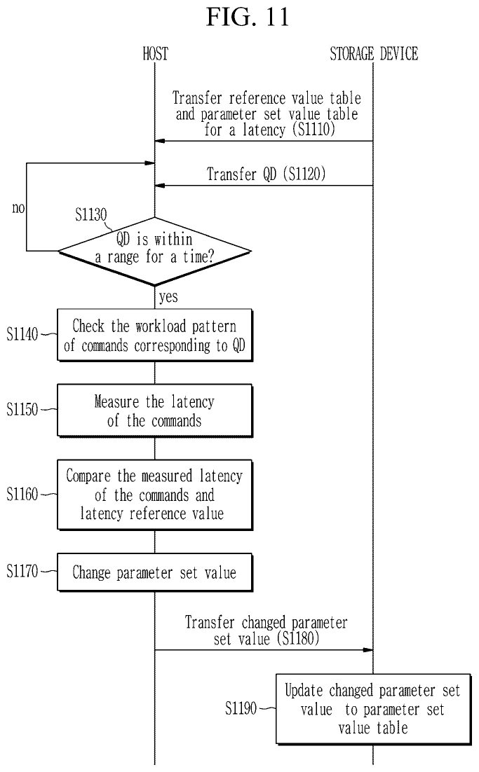

FIG. 11 is a flowchart of the operation of a storage system according to some embodiments.

In an embodiment, the storage device may transmit to the host a reference value table defining reference values of latency and a parameter setting value table defining setting values of parameters related to latency S1110. The host may store the reference value table and parameter setting value table received from the storage device in a buffer memory within the host. Here, reference values in the reference value table and parameter setting values in the parameter setting value table may be determined by the queue depth and workload patterns. Workload patterns may include, but is not limited to, data chunk sizes, percentiles of tail latency, and the ratio of read requests to write requests.

In an embodiment, the storage device may transmit a queue depth (QD) as the number of commands currently being processed to the host S1120. The storage device may transmit the queue depth (QD) to the host at a predetermined time or periodically.

In an embodiment, the host may determine whether the queue depth (QD) within a predetermined range during the measurement window S1130. The section of the range for determining that the queue depth (QD) is within a given range may be variously changed. The number and size of measurement windows for determining that the queue depth (QD) is within a given range may be variously changed.

In an embodiment, the host may check the workload pattern of commands corresponding to the queue depth (QD) if the queue depth (QD) is within a predetermined range during the measurement window S1140. Here, workload may include, but is not limited to, data chunk size, percentile of tail latency, and ratio of read requests to write requests.

In an embodiment, the host may measure the latency of commands corresponding to the queue depth (QD) if the queue depth (QD) is within a predetermined range during the measurement window S1150. Specifically, the host may measure the time from the time the host transmits commands corresponding to the queue depth (QD) to the storage device to the time the storage device transmits a signal indicating that command processing is complete to the host as the latency of the commands.

In an embodiment, the host may compare the measured latency of commands corresponding to the queue depth (QD) with a latency reference value of a reference value table S1160. The host may compare the measured latency with a latency reference value in the reference value table based on the queue depth (QD) and the workload pattern of commands corresponding to the queue depth (QD). In an embodiment, the host may change a setting value of a parameter related to the measurement latency if the host compares the measurement latency of commands corresponding to the queue depth (QD) with a reference latency of a reference value table and, as a result, determines that the measurement latency of the commands corresponding to the queue depth (QD) is greater than a reference value of the reference value table S1170. For example, the host may adjust at least one of a read delay, an erase suspend delay, an erase delay max count, and a program suspend delay to control the read latency of commands corresponding to a queue depth (QD). Alternatively, the host may adjust at least one of the settings of the write latency, the erase suspend latency, the erase latency max count, the start throttling write cache count, and the throttling write cache latency to control the write latency of commands corresponding to the queue depth (QD). However, it is not limited to this.

In an embodiment, the host may transmit the changed parameter setting values to the storage device S1180. The storage device may update the changed parameter setting values in the parameter setting value table S1190.

Meanwhile, factors for determining the performance of the storage device 30 may include not only latency but also throughput or power consumption. Depending on the usage environment of the storage system 10, the performance of the storage device 30 may be expressed as a result value, such as throughput or power consumption. Here, throughput may be the number of input/output operations per second (IOPS) for input/output conditions such as random read, random write, sequential read, and/or sequential write of the storage device 30. Therefore, in order for the storage device 30 to meet the performance required by the host device 20, the host device 20 needs to dynamically adjust parameters related to throughput or power consumption within the storage device 30.

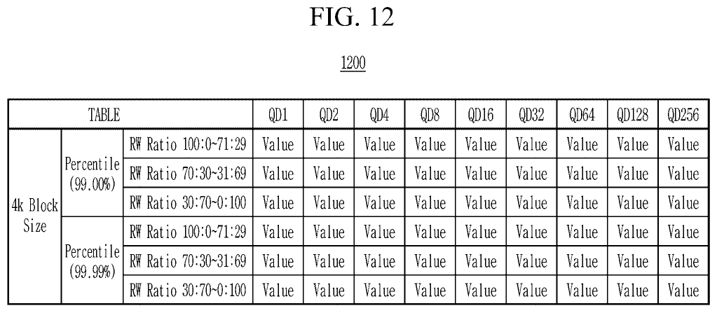

FIG. 12 is a table showing reference values of power consumption or throughput of a storage device stored in memory in an exemplary embodiment. In an embodiment, the reference values for power consumption or throughput may be stored in a memory 123 (of FIG. 5) within the memory controller 31 (of FIG. 5) in the form of a table 1200.

In an embodiment, the reference value of power consumption or throughput may have different values depending on the queue depth and the workload pattern of commands corresponding to the queue depth. The reference value of power consumption or throughput may be a predetermined value that is optimized in a pre-shipment test evaluation of the storage device 30 to meet the performance required by the host device 20. Here, the workload pattern may include, but is not limited to, data chunk sizes of commands that the host device 20 transmits to the storage device 30, percentiles of tail latency, and the ratio of read requests to write requests. The queue depth section and the workload pattern section of the reference value table 1200 of power consumption or throughput may be determined differently depending on the test evaluation criteria or customer request.

In an embodiment, the host device 20 may receive a reference value table 1200 of power consumption or throughput from the storage device 30. The host device 20 may receive the queue depth as the number of the command currently being processed from the storage device 30, and check whether queue depth is within the predetermined range during the measurement window. The host device 20 may determine the workload pattern of commands corresponding to the queue depth, and measure the power consumption of the storage device 30 or the throughput of the storage device 30 when performing commands corresponding to the queue depth. The host device 20 may compare the measured power consumption or measured throughput with a reference value of power consumption or a reference value of throughput. The host device 20 may change the setting values of corresponding parameters based on the comparison result between the measured power consumption and the reference value of the power consumption or the comparison result between the measured throughput and the reference value of the throughput.

Meanwhile, in an embodiment, the operation of the host device 20 to dynamically adjust parameters related to throughput or power consumption within the storage device 30 is the same as or similar to the method described in FIG. 5 to FIG. 11, and therefore, a detailed description of the operation method of the host device 20 and the storage device 30 is omitted here.

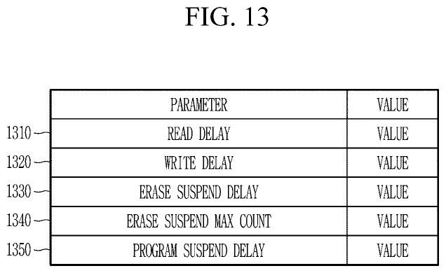

FIG. 13 indicates parameters according to an exemplary embodiment. In an embodiment, the host device 20 may change the setting values of some or all of the parameters of FIG. 13 to control the power consumption or throughput of commands corresponding to the queue depth received from the storage device 30.

In an embodiment, the host device 20 may adjust a read delay 1310 and/or a write delay 1320 of the storage device 30 to reduce power consumption of the storage device 30. As the setting values of the read delay 1310 and the write delay 1320 decrease, the read command and/or the write command may be processed quickly, so the power consumed by the storage device 30 may be reduced.

In an embodiment, the host device 20 may adjust the setting values of the read delay 1310, the write delay 1320, the erase suspend delay 1330, the erase delay max count 1340, and/or the program suspend delay 1350 to control the throughput of the storage device 30. For example, if the set values of the read delay 1310 and the write delay 1320 are reduced, the read command and/or the write command may quickly input, so the throughput for the read command and/or the write command of the storage device 30 may increase. For example, if the setting values of the erase pause delay 1330 and the erase delay max count 1340 are reduced, the latency of the read command and the write command may become faster, so the throughput for the read command and the write command of the storage device 30 may increase. For example, if the setting value of the program suspend delay 1350 is reduced, the latency of the read command may become faster, so the throughput for the read command of the storage device 30 may increase.

According to an embodiment, the host device 20 may dynamically adjust internal parameters of the storage device 30 according to the usage environment of the host device 20, thereby enabling the storage device 30 to meet the performance required by the host device 20 according to the usage environment of the host device 20.

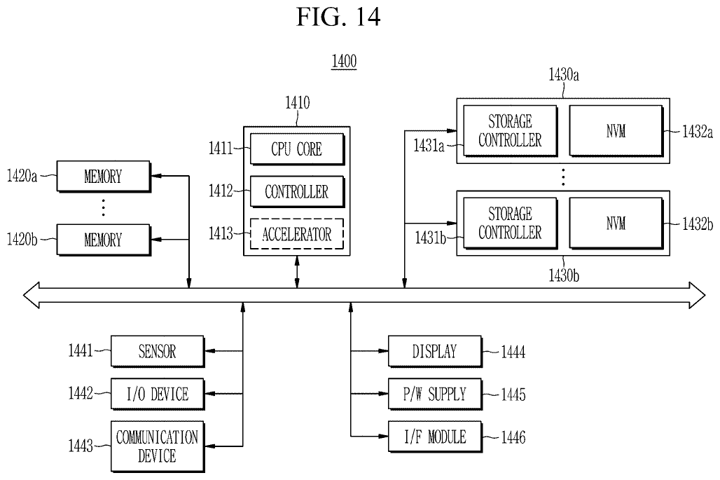

FIG. 14 is a diagram illustrating a system to which a storage device according to some embodiments is applied.

The system 1400 may include a main processor 1410, a memory 1420a, 1420b, and a storage device 1430a, 1430b, and may further include a sensor 1441, an input/output device (I/O DEVICE) 1442, a communication device 1443, a display 1444, a power supply device (P/W SUPPLY) 1445, and an interface module (I/F MODULE) 1446.

The main processor 1410 may control the overall operation of the system 1400, more specifically, the operation of other components that make up the system 1400. Such a main processor 1410 may be implemented as a general-purpose processor, a dedicated processor, or an application processor.

The main processor 1410 may include one or more CPU cores 1411 and may further include a controller 1412 for controlling memory 1420a, 1420b and/or storage devices 1430a, 1430b. In some embodiments, the main processor 1410 may include an accelerator 1413, which is a dedicated circuit for high-speed data operations, such as artificial intelligence (AI) data operations. Such an accelerator 1413 may include a GPU (Graphics Processing Unit), an NPU (Neural Processing Unit), and/or a DPU (Data Processing Unit), and may be implemented as a separate chip that is physically independent from other components of the main processor 1410.

The memory 1420a, 1420b may be used as a main memory device of the system 1400 and may include a volatile memory such as SRAM and/or DRAM, but may also include a non-volatile memory such as flash memory, PRAM and/or RRAM. The memory 1420a, 1420b may also be implemented within the same package as the main processor 1410.

The storage device 1430a, 1430b may include a storage controller 1431a, 1431b and non-volatile memory 1432a, 1432b. In an embodiment, the storage device 1430a, 1430b may be a storage device described with reference to FIG. 1 to FIG. 13. The storage device 1430a, 1430b may operate based on the operating method described with reference to FIG. 1 to FIG. 13.

The storage device 1430a, 1430b may be included in the system 1400 physically separated from the main processor 1410, or may be implemented within the same package as the main processor 1410. Additionally, the storage device 1430a, 1430b may be removably coupled to another component of the system 1400 through an interface such as the interface module 1446 described later, by having the form of SSD or memory card. Such storage devices 1430a, 1430b may be devices to which standard specifications such as UFS (Universal Flash Storage), eMMC (embedded multi-media card), or NVMe (non-volatile memory express) are applied, but are not necessarily limited thereto.

The sensor 1441 may detect various types of physical quantities that can be obtained from outside the system 1400 and convert the detected physical quantities into electrical signals. Such sensors 1441 may be temperature sensors, pressure sensors, light sensors, position sensors, acceleration sensors, biosensors, and/or gyroscope sensors.

The user input device 1442 may receive various types of data input from a user of the system 1400 and may be a touch pad, a keypad, a keyboard, a mouse, and/or a microphone.

The communication device 1443 may transmit and receive signals between other devices outside the system 1400 according to various communication protocols.

Such a communication device 1443 may be implemented including an antenna, a transceiver, and/or a modem.

The display 1444 may function as an output device that outputs visual information to a user of the system 1400.

The power supply device 1445 may appropriately convert power supplied from a battery (not shown) built into the system 1400 and/or an external power source and supply it to each component of the system 1400.

An interface module 1446 may provide a connection between the system 1400 and an external device that is connected to the system 1400 and can exchange data with the system 1400. The interface module 1446 may be implemented in various interface methods such as ATA (Advanced Technology Attachment), SATA (Serial ATA), e-SATA (external SATA), SCSI (Small Computer Small Interface), SAS (Serial Attached SCSI), PCI (Peripheral Component Interconnection), PCIe (PCI express), NVMe, IEEE 1394, USB (universal serial bus), SD (secure digital) card, MMC (multi-media card), eMMC, UFS, eUFS (embedded Universal Flash Storage), CF (compact flash) card interface, NVMe-MI (NVMe management interface), etc.

Although the embodiments of the present invention have been described in detail above, the scope of the present invention is not limited thereto, and various modifications and improvements made by those skilled in the art using the basic concept of the present invention defined in the following claims also fall within the scope of the present invention.

What is claimed is:

1. A storage system comprising:
a storage device comprising a queue depth manager configured to detect a queue depth corresponding to the number of commands being processed and output the queue depth; and
a host device comprising a memory and a performance controller,
wherein the memory is configured to store reference value of an element for determining the performance of the storage device and setting values of parameters for meeting the reference value of the element, and
wherein the performance controller is configured to receive the queue depth and change the setting values of the parameters based on a comparison result between a measured value of the element corresponding to the commands and the reference value of the element.

2. The storage system of claim 1, wherein:
the performance control unit is configured to monitor whether the queue depth is within a first range for a first time, obtain the measured value when the queue depth is within the first range for the first time, adjust the setting values based on the comparison result between the measured value and the reference value, and output the adjusted setting values.

3. The storage system of claim 2, wherein:
the storage device further comprises parameter control circuit configured to receive the adjusted setting values and control the storage device to operate according to the adjusted setting values.

4. The storage system of claim 2, wherein:
the queue depth is within the first range for the first time is the queue depth is 1 for the first time, or the queue depth is greater than or equal to 2ⁿ⁻¹ and less than or equal to 2ⁿ for the first time, wherein the n is an integer greater than or equal to 2.

5. The storage system of claim 1, wherein:
the queue depth manager is configured to output the queue depth for a predetermined time or periodically.

6. The storage system of claim 1, wherein:
the reference value of the element and the setting values of the parameters have different values depending on the queue depth and workload pattern of the commands.

7. The storage system of claim 6, wherein:
the workload pattern comprises a data chunk size, a tail latency percentile, and a ratio of read requests to write requests (RW ratio).

8. The storage system of claim 1, wherein:
the parameters comprise one or more of a read delay, a write delay, an erase suspend delay, an erase suspend max count, and a program suspend delay of the storage device.

9. The storage system of claim 8,
wherein the element is latency.

10. The storage system of claim 9, wherein:
the parameters further comprise one or more of start throttling write cache count and throttling write cache delay of the storage device.

11. The storage system of claim 9, wherein:
the measured value of the element is the time from the time the host device transmits a request signal to the storage device to instruct the processing of the commands to the time the storage device transmits a signal to the host device to indicate the processing of the commands has been completed.

12. The storage system of claim 1,
wherein the element is power consumption or throughput of the storage device.

13. A method of operating a host device comprising:
receiving a reference value of latency of a storage device determined according to a queue depth and a workload pattern and setting values of parameters of the storage device for the reference value;
receiving the queue depth as the number of the commands queued in a command queue of the storage device;
monitoring whether the queue depth is within a first range for a first time;
determining the workload pattern of the commands;
measuring the latency of the commands and obtaining the measured latency;
comparing the measured latency and the reference value; and
adjusting the setting values of the parameters based on a comparison result between the measured latency and the reference value.

14. The method of operating the host device of claim 13, further comprising:
outputting the adjusted setting values so that the storage device operates based on the adjusted setting values of the parameters.

15. The method of operating the host device of claim 13, comprising:
if the queue depth is not within the first range for the first time, receiving the queue depth until the queue depth is within the first range.

16. The method of operating the host device of claim 13, wherein:
the workload pattern comprises one or more of a data chunk size, a percentile of tail latency, and a ratio of read requests to write requests.

17. The method of operating the host device of claim 13, wherein:
the parameters comprise one or more of read latency, write latency, erase suspend latency, erase delay max count, program suspend latency, start throttling write cache count, and throttling write cache latency.

18. A storage device comprising:
a memory configured to store a reference value of latency according to a queue depth and a workload pattern and setting values of parameters to meet the reference value;
a queue depth manager configured to detect the queue depth corresponding to the number of the commands being processed and output the queue depth; and
a parameter controller configured to receive changed setting values of the parameters.

19. The storage device of claim 18, wherein:
the parameter controller is configured to change the setting values of the parameters stored in the memory to the changed setting values.

20. The storage device of claim 18, wherein:
the queue depth manager is configured to output the queue depth for a predetermined time or periodically.
